(19) United States
(12) Patent Application Publication
(10) Pub. No.: US 2004/0098249 A1
(43) Pub. Date: May 20, 2004

(54) Method and system to utilize web resources for language vocabulary learning

(76) Inventors: Yaliang Wang, Cerritos, CA (US); Cun Wang, Cerritos, CA (US); Xiaoling Guo, Cerritos, CA (US)

Correspondence Address: Xiaoling Guo, 18528 Casandra Avenue, Cerritos, CA, 90703, US

(21) Appl. No.: 10/298,280

(22) Filed: Nov. 18, 2002

(51) Int. Cl. G06F 17/27

(52) U.S. Cl. 704/9

(57) ABSTRACT

This specification discloses a method and system to utilize Web resources for learning language words and phrases that are found in either general language study or specific language tests, such as SAT, GRE, TOEFL and GMAT, etc. The vocabulary and Web resource information are indexed and stored into a vocabulary database. From a user interface, learners view the vocabulary and open a Web page on which the current word or phrase is used. The vocabulary is automatically found and highlighted in the text of Web pages to attract learners' attention. The data in the database are routinely audited to check whether or not the index of vocabulary and Web resource information is valid. The major advantage of the present invention is to fully utilize a large number of free and easily accessible stories, fictions, essays and notes on the Web for language vocabulary learning.

### BACKGROUND OF THE INVENTION

The present invention relates to a method and system for learning language vocabulary through a computer and the Internet. More particularly, the invention relates to a method and system to utilize Web resources for learning language words and phrases that are found in either general language study or specific language tests, such as Scholastic Aptitude Tests (SAT), Graduate Record Examination (GRE), Test of English as a Foreign Language (TOEFL) and Graduate Management Admission Test (GMAT), etc. This invention is also applied to other fields of language learning, including spelling, grammar and reading.

There are many prior art solutions on use of computers and the Internet in language learning and teaching. Pictures, games and puzzles are popular methods and applications of computer-assisted language learning. With the advent of the Internet, distance learning, on-line instruction, training material publishing, learning resource remote access and cross-reference through hyper linking of Web pages have been fast developed. The Web has become a key component for methods and systems of current language learning. However, all these existing solutions mainly focus on use of Web as a communication tool for language learning.

The present invention is derived from a completely new concept, that is, use of the collection of Web resources as a book for language learning. Even current technologies have been advanced, reading books is still the most important method for people to learn languages because any other way, such as picture, game and puzzle, can not take the place of book to provide learners the rich and complete context. The collection of whole Web resources is such a great book, and there are a large number of stories, fictions, essays and notes in it. This invention is an initiative to focus on a method and system to read this great book efficiently for language learning.

### BRIEF SUMMARY OF THE INVENTION

The main idea of the present invention is that the Web is not only a communication tool but also a great and unique book. A large number of words and phrases are in Web resources and placed in rich and varied context of stories, fictions, essays and notes.

It is an object of the present invention to develop a method and system to efficiently utilize Web resources for language vocabulary learning.

In this invention, the method mainly comprises:

(a) organizing and storing words and phrases into a vocabulary database;

(b) finding and selecting Web pages for each word and phrase;

(c) indexing Web pages using vocabulary as keywords;

(d) auditing and updating index of vocabulary and Web resource information;

(e) selecting and displaying vocabulary and Web resource information from the vocabulary database randomly but giving every word an equal probability to be viewed;

(f) opening a Web page on which the current word or phrase is used;

(g) automatically finding and highlighting the word or phrase in the text of Web pages;

(h) designing a small vocabulary-viewing window located on a corner of screen and an independent client application to match learners' multiple learning schedules.

Based on the method and system of the invention, the Web resources can be efficiently used for language vocabulary learning. The organized words and phrases in the vocabulary database provide a key to access Web resources. Because each word or phrase has a linkage to some specific Web pages, the learners can quickly find the right Web page to read. Automatically finding and highlighting vocabulary in the text of Web pages can attract learners' attention to the current word before they read through the whole story. Since Web pages are often updated and changed, it is necessary to audit and update the index for Web resources routinely. The design of small vocabulary-viewing window located on a corner of screen allows the vocabulary-viewing window to work with a Web browser or other applications to match learners' multiple learning schedules, such as learning in a language class or at home, after logging on the computer, before logging out the computer, or during breaks from doing other jobs. The client application is designed as an independent application that can provide full functionality no matter whether or not the computer is on-line or off-line, so that learners can learn vocabulary as scheduled.

It is an advantage of the present invention to fully utilize a large number of free and easily accessible Web resources for language vocabulary learning. Currently there are a large number of learning materials on the Web. By using the method and system of the present invention, learners can efficiently learn both common and uncommon words and phrases from Web resources. Students who are preparing for SAT, GRE, TOEFL or GMAT usually need to memorize a list of uncommon words and phrases because the vocabulary that they have learned in books are limited. The present invention provides them a way to efficiently learn these words and phrases in the context of stories, fictions, essays and notes on the Web.

It is another advantage of the present invention to automatically find and highlight vocabulary in the text of Web pages before learners read Web resources. Because learners view the vocabulary first and then open a Web page with the question about where and how this word or phrase is used, it is very important to attract their attention to the current vocabulary in the text to provide a mnemonic aid.

It is another advantage of the present invention to match learners' multiple learning schedules no matter whether or not the computer is on-line or off-line. Learners usually have multiple learning schedules to learn language vocabulary. Learning in classes or spend several hours at home are conventional ways. Sometimes, learners also like to take a short time, such as after logging on the computer, before logging out the computer, or during breaks from doing other jobs, to learn some vocabulary. The present invention approaches to this goal by designing a small vocabulary-viewing window located on a corner of screen and an independent client application.

### BRIEF DESCRIPTION OF THE DRAWINGS

For a more complete understanding of the invention, reference is made to the following Detailed Description of the Invention, and the accompanying drawings, in which

FIG. 1 shows a concept of using the collection of Web resources as a book for language learning, from which the present invention is derived.

FIG. 2 shows an overview of method and system of the present invention.

FIG. 3 is a flow diagram showing the steps for auditing the index of vocabulary and Web resource information.

FIG. 4 illustrates an algorithm in the present invention to select and display vocabulary in the database randomly but give every word an equal probability to be viewed.

### DETAILED DESCRIPTION OF THE INVENTION

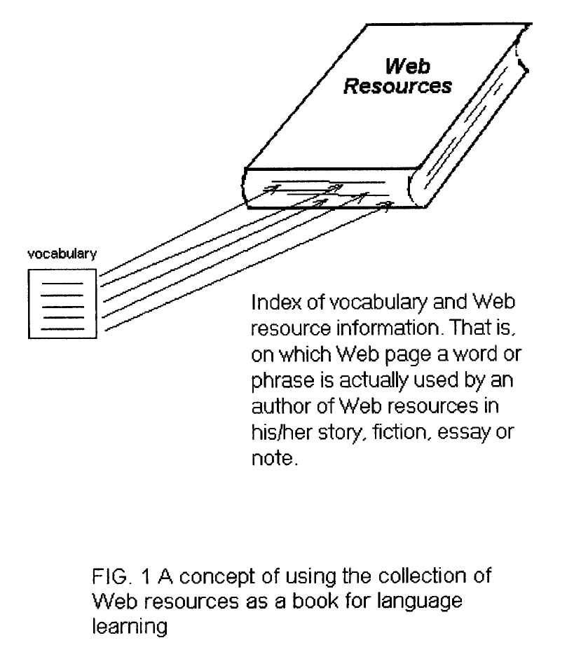

As shown in FIG. 1, the present invention is derived from an idea that the whole collection of Web resources is a book, and how to efficiently use this great book for language learning is an important field that needs to be developed. The distance learning, on-line instruction, training material publishing and learning resource remote access have been fast developed on the Web, but they mainly focus on use of Web as a communication tool for language learning. Since the Web page has a feature of hyper linking, there are also many solutions to index some related Web pages on one page and link some contents from a Web page to others, but their major purpose is to make quick and convenient cross-references. There is no method and system to systematically use some basic components of the language, such as vocabulary, as a key to open a large number of Web pages and highlight the vocabulary in their text for language learning purpose.

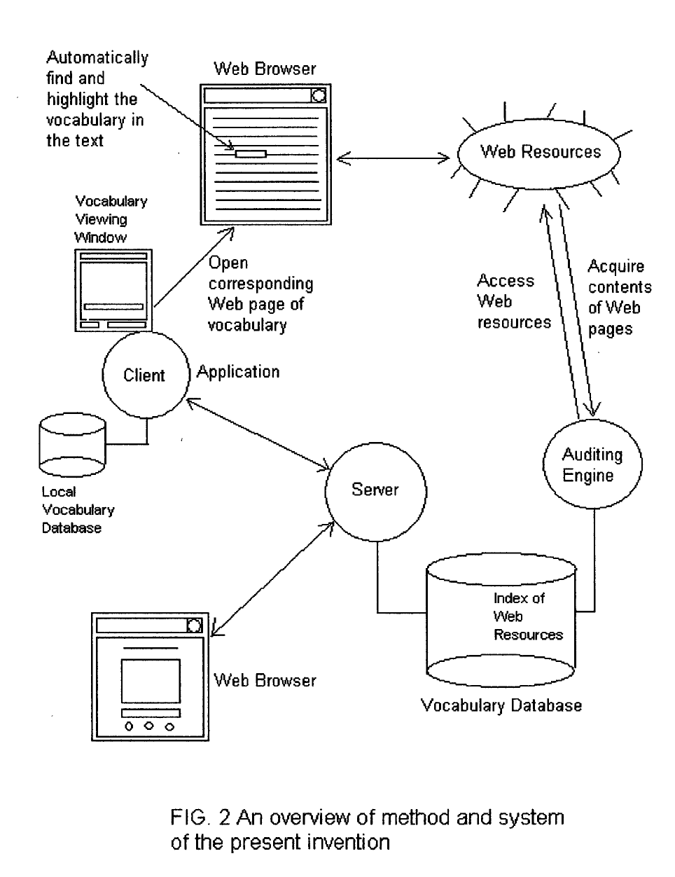

FIG. 2 shows an overview of method and system of the present invention. The architecture is based on the client/server model. The data of vocabulary and Web resource information are stored in a vocabulary database and indexed each other. The server retrieves indexed information from the database and sends them to the client. The client is either a Web browser or an application with a vocabulary-viewing window. If the client is a Web browser, the words and phrases are viewed on the Web browser, and the vocabulary and corresponding Web pages are linked with hyper linking. When users click on the link of Web resources, the corresponding Web pages are loaded on the Web browser. If the client is an application, the vocabulary and Web resource information are shown on vocabulary-viewing window. When the link of Web resources is clicked, the application launches a Web browser, opens the corresponding Web page, and automatically finds and highlights the current word or phrase in the text of Web page for users' viewing. When the computer is on-line, the application updates information in the local vocabulary database for users' viewing again or while the computer is off-line. An auditing engine is responsible for checking whether or not the index of vocabulary and Web resource information is valid.

The method of the present invention mainly comprises several steps related with the data flow of vocabulary and Web resource information. First, words and phrases are stored into the vocabulary database and categorized as private, SAT, GRE, TOEFL, GMAT vocabulary, etc. Then the corresponding Web pages of vocabulary are selected and indexed in the database using vocabulary as keywords. The data are also routinely retrieved from the database and matched with the contents of actual Web pages to audit whether or not the index of vocabulary and Web resource information is valid. Finally, the data are retrieved from the database to be viewed.

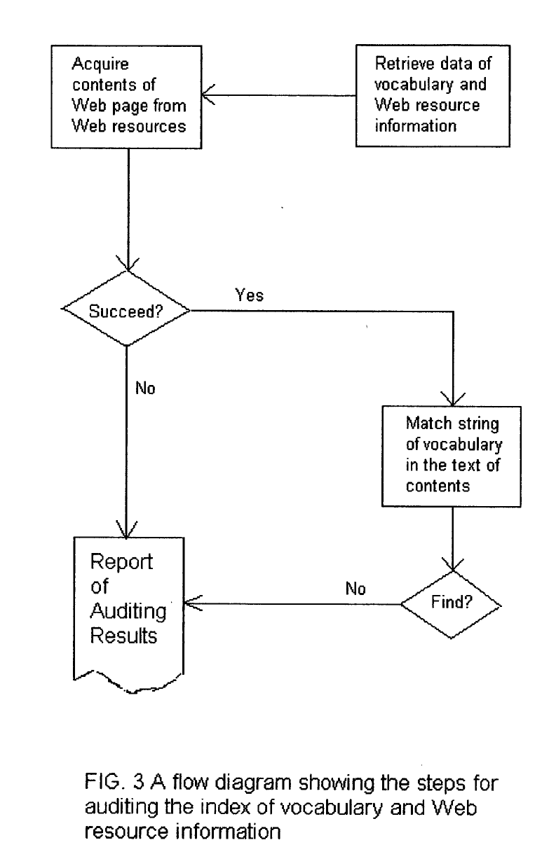

FIG. 3 is a flow diagram showing the steps for auditing the index of vocabulary and Web resource information. Because the addresses and contents of Web pages often change, it is important to routinely check whether or not the index of vocabulary and Web resource information is valid. First, the data of vocabulary and Web resource information are retrieved from the vocabulary database. Then the contents of Web pages are acquired from the Web resources. If the contents of Web resources are failed to acquire, that means the Web resource information is invalid for the vocabulary. If the contents of Web resources are acquired successfully, the string of vocabulary is matched with the text of Web pages. If the string of vocabulary cannot be found in the text of a Web page, that means the Web page has been changed and then is invalid. The auditing results are used for updating the index of vocabulary and Web resource information in the vocabulary database. This auditing process ensures that the vocabulary can be found in the text of Web pages when learners open a Web page to read.

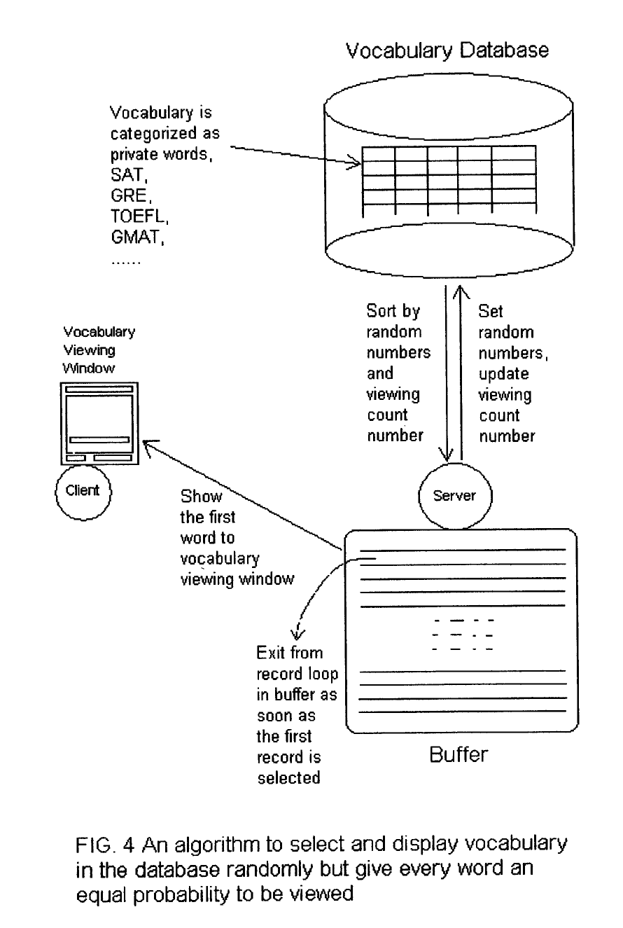

FIG. 4 illustrates an algorithm in the present invention to select and display vocabulary in the database randomly but give every word an equal probability to be viewed. The words and phrases are retrieved from the database with user identification (ID) and category code. In a specific category, a word is randomly selected from the database according to random numbers set every time when it is viewed. The word with the smallest random numbers is first selected by utilizing ascendant sort function of relational database. At the same time, words and phrases are also grouped and sorted with the viewing count number. Except a word has been set a viewing priority described hereinafter, a word with larger viewing count number is not viewed again prior to all words with smaller viewing count number. This ensures that every word has an equal probability to be viewed. Based on ascendant sort function, the target word is always the first record in the buffer. Then the program of data selection exits from the record loop as soon as the first record is selected to eliminate redundancy and speed up the retrieval process.

There are two additional methods associated with the algorithm to select and display vocabulary. One is to set viewing priority and another is to move the vocabulary to private word box. These two methods provide learners options to view some words and phrases more frequently for some special learning purposes during certain period. For example, if a learner sets the viewing priority of a word as “appear every 8 words”, this word is viewed every other 8 words are viewed. The users can also move words or phrases that they want to learn particularly into the private word box to repeatedly learn and memorize.

The private word box also provides learners the functionality to input and edit their own words and phrases. The basic functions include adding, deleting, updating words and phrases. Both the vocabulary moved into the private word box and the vocabulary entered by learners themselves can be edited and updated. The words and phrases in private word box can also be changed from active status to inactive status, or vice versa. This allows learners to keep some words and phrases in the database to be activated for learning again in the future.

After the data are retrieved from the database, the vocabulary can be viewed in viewing style or testing style. In the viewing style, the displayed information about vocabulary is definition, example and hint etc. In the testing style, the multiple-choice quizzes for vocabulary usage or definition and history of testing scores are displayed. The Web resource information is always shown for learners to open the corresponding Web pages. The user interface could be either a Web browser or the vocabulary-viewing window of the application. When users click on the link of Web resources, the corresponding Web pages are loaded on the Web browser. The client application also automatically finds and highlights the current word or phrase in the text of Web page to attract learners' attention.

The vocabulary-viewing window of the application is particularly designed to match learners' multiple learning schedules. For learning language vocabulary, learners can take language classes, or spend several hours themselves to specially learn vocabulary, or just use several minutes after logging on computer, before logging out computer, or during breaks from doing other jobs on the computer. To match learners' these multiple schedules, the vocabulary-viewing window is designed as small as possible, and located on a corner of screen to easily work together with a Web browser or other applications. Because learners may use a desktop or notebook computer in the class or at home, and the computer may connect or disconnect with the Internet, the client application is designed as an independent application that connects to the server dynamically according to the Internet connectivity. When the Internet is connected, the application communicates with server and retrieves new vocabulary and Web resource information from the vocabulary database on the server. When the computer is off-line, the application works independently itself by using local vocabulary database in which the data are updated while the computer is on-line. The users can set time to display the next vocabulary automatically. Whenever the next vocabulary is displayed, the vocabulary-viewing window shows up on the top of screen to attract learners' attention. The vocabulary-viewing window also automatically shows up when learners start the computer or log on the computer.

The present invention particularly focuses on providing rich and complete context for learners to learn and memorize language vocabulary. The importance of context in language learning has been emphasized by many language specialists and teachers. Researches have shown that the efficiency of memorizing vocabulary in context is greatly higher than memorizing a list of words and phrases only. This invention utilizes rich and varied context of Web resources to give learners a deep impression on the current word or phrase to provide a mnemonic aid.

By using the method and system of the present invention, learners can fully utilize a large number of free and easily accessible Web resources for vocabulary learning. The words and phrases that they want to learn are on the Web with rich and varied context and can be easily accessed via the Internet. By use of a large number of learning materials on the Web to cover enough words and phrases, the present invention can meet learners' needs to learn many common and uncommon words and phrases in the context, and be of benefit to students who will take SAT, GRE, TOEFL and GMAT, etc.

Automatically finding and highlighting vocabulary in the text of Web pages can attract learners' attention to the current word before they read Web resources. By designing a small vocabulary-viewing window located on a corner of screen and an independent client application which performs full functionality no matter whether or not the computer is on-line or off-line, the method and system also match learners' multiple learning schedules, such as learning in classes or at home, after logging on the computer, before logging out the computer, or during breaks from doing other jobs.

It will be appreciated that although the invention is described with respect to several features and embodiments, the scope of the invention is to be limited only by the scope of the claims and equivalents thereof.

What is claimed is:

1. A method of utilizing Web resources for language vocabulary learning, said method comprising the steps of:
(a) organizing and storing words and phrases into a vocabulary database;
(b) finding and selecting Web pages for each word and phrase;
(c) indexing Web pages using vocabulary as keywords;
(d) auditing and updating the index of vocabulary and Web resource information;
(e) retrieving vocabulary and Web resource information from the vocabulary database; and
(f) opening a Web page on which the current word or phrase is used.

2. The method in accordance with claim 1, said method comprising the further steps of:
(a) automatically finding and highlighting the vocabulary in the text of Web pages whereby learners can pay attention to the current vocabulary before reading Web resources;
(b) designing a small vocabulary-viewing window located on a corner of screen whereby said vocabulary-viewing window can work together with a Web browser and other applications; and
(c) designing an independent client application that communicates with the sever while the computer is on-line, and works independently while the computer is off-line whereby said client application can perform full functionality no matter whether or not the computer is connected to the Internet.

3. The method according to claim 1, wherein the vocabulary and Web resource information in the database are randomly selected and displayed but every word is given an equal probability to be viewed.

4. The method in accordance with claim 3, said method further comprising the steps of:
(a) setting random numbers to the vocabulary when it is viewed;
(b) updating viewing count number for the vocabulary when it is viewed; and
(c) using ascendant sort and group functions of relational database to put the target vocabulary as the first record in the buffer whereby the vocabulary can be fast and efficiently selected.

5. The method according to claim 1, wherein the vocabulary is set a viewing priority to control the display frequency of some words and phrases.

6. The method according to claim 1, wherein the vocabulary and Web resource information are moved to private word box to be particularly viewed and learned.

7. A language vocabulary learning system utilizing Web resources, which system comprises:
(a) a vocabulary database, which stores vocabulary data and Web resource information;
(b) an auditing engine, which accesses Web resources, acquires the contents of Web pages, and matches the string of vocabulary with the text of contents to check whether or not the index of vocabulary and Web resource information is valid;
(c) a server, which retrieves data from the vocabulary database and sends them to a Web browser or a client application;
(d) a Web browser, which displays vocabulary and Web resource information, opens the corresponding Web page of the vocabulary;
(e) a client application, which displays vocabulary and Web resource information, opens the corresponding Web page of the vocabulary, and automatically finds and highlights the vocabulary in the text of the Web page; and
(f) a local vocabulary database, which stores updated vocabulary and Web resource information to be viewed again or while the computer is off-line.

8. The system according to claim 7, wherein an item of data in the vocabulary database comprises vocabulary, definition, example, hint, and Web resource information.

9. The system according to claim 7, wherein said display of vocabulary and Web resource information comprises:
(a) displaying vocabulary and Web resource information;
(b) displaying multiple-choice quizzes for testing definition and usage of vocabulary;
(c) displaying the history of testing scores; and
(d) automatically showing up the next word or phrase according to time interval set by users.

10. The system in accordance with claim 7, said system further comprises:
(a) setting viewing priority to vocabulary;
(c) moving vocabulary to the private word box; and
(c) activating, inactivating, adding, updating and deleting the vocabulary in the private word box.
